(19) United States
(12) Patent Application Publication
(10) Pub. No.: US 2024/0298233 A1
(43) Pub. Date: Sep. 5, 2024

(54) Method for Inter-Radio Access Technology Handover

(71) Applicant: MEDIATEK INC., Hsin-chu (TW)

(72) Inventors: Chun-Li Kuo, Hsinchu City (TW); Chun-Shen Sung, Hsinchu City (TW)

(73) Assignee: MEDIATEK INC., Hsin-chu (TW)

(21) Appl. No.: 18/503,191

(22) Filed: Nov. 7, 2023

Related U.S. Application Data
(60) Provisional application No. 63/487,630, filed on Mar. 1, 2023.

(51) Int. Cl. H04W 36/08; H04B 17/318; H04W 36/00

(52) U.S. Cl. CPC H04W 36/087; H04B 17/328; H04W 36/00226; H04W 36/0058

(57) ABSTRACT

A method for inter-radio access technology (inter-RAT) handover includes establishing New Radio (NR) connection between user equipment (UE) and a network, sending first Measurement Report by the UE to the network when one of following conditions occurs: New Radio (NR) signal quality does not satisfy an NR signal threshold, Real-time Transport Protocol (RTP) measurement does not satisfy an RTP threshold, and the UE changes a calling preference to voice over Wi-Fi (VoWiFi). The method further includes triggering a handover from VoNR to voice over LTE (VoLTE) by the network, and triggering a handover from VoLTE to VoWiFi by the UE.

### CROSS REFERENCE TO RELATED APPLICATIONS

This application claims the benefit of U.S. Provisional Application No. 63/487,630, filed on Mar. 1, 2023. The content of the application is incorporated herein by reference.

### BACKGROUND

Voice over New Radio (VoNR) is a technology that enables voice calls over 5G networks. VoNR uses the 5G core network and radio access network to deliver high-quality voice services without relying on legacy circuit-switched networks or fallback mechanisms. VoNR offers several benefits, such as lower latency, higher bandwidth, better coverage, and improved reliability. VoNR also supports enhanced voice features, such as wideband voice, video calling, and rich communication services (RCS).

On 2G and 3G networks, voice calls are carried by dedicated channels that use circuit switching technology. This means that a physical connection is established between the caller and the receiver, and a fixed amount of bandwidth is allocated for the duration of the call. This not only ensures a consistent quality of service, but also limits the number of simultaneous calls that can be supported by the network.

On 4G networks, voice calls are carried by packet switching technology, which means that voice data is divided into small packets and transmitted over the network along with other types of data. This not only allows for more efficient use of network resources, but also introduces challenges such as latency, jitter, and packet loss. To overcome these challenges, 4G networks use a technology called voice over LTE (VoLTE), which optimizes the network for voice traffic and provides quality of service guarantees.

On 5G networks, voice calls are also carried by packet switching technology, but with some key differences. 5G networks use a new core network architecture that is more flexible, scalable, and secure than previous generations. 5G networks also use a New Radio (NR) access technology that supports higher frequencies, wider bandwidths, and multiple antenna configurations. These features enable 5G networks to provide faster speeds, lower latency, and higher capacity than 4G networks. VoNR is the technology that leverages these features to deliver voice services over 5G networks. VoNR uses the same core network and radio access network as other 5G services, which means that it does not need any fallback mechanisms or legacy networks to support voice calls. VoNR also supports enhanced voice features, such as HD voice, video calling, and rich communication services. VoNR is expected to offer better voice quality, reliability, and user experience than previous technologies.

On the other hand, voice over Wi-Fi (VoWiFi) allows users to make and receive voice calls over a wireless network, such as a home or office Wi-Fi. VoWiFi can offer several benefits, such as improved call quality, lower costs, and wider coverage. VoWiFi requires a compatible device, a VoWiFi service provider, and a Wi-Fi network that meets certain quality standards. VoWiFi can also work with cellular networks, enabling seamless handover between Wi-Fi and mobile data.

One of the challenges of implementing voice services over 5G networks is the seamless handover between different radio access technologies, such as voice over VoWiFi and VoNR. Currently, the network operators core network does support direct handover between VoWiFi and VoNR. This means that the call may be dropped or interrupted when the poor NR signal quality occurs. This can cause user dissatisfaction and affect the quality of service. Therefore, it is important to develop solutions that can enable smooth and reliable handover between VoWiFi and VoNR in 5G networks.

### SUMMARY

An embodiment provides a method for inter-radio access technology (inter-RAT) handover including establishing New Radio (NR) connection between user equipment (UE) and a network, sending first Measurement Report by the UE to the network when one of following conditions occurs: New Radio (NR) signal quality does not satisfy an NR signal threshold, Real-time Transport Protocol (RTP) measurement does not satisfy an RTP threshold, and the UE changes a calling preference to voice over Wi-Fi (VoWiFi). The method further includes triggering a handover from VoNR to voice over LTE (VoLTE) by the network, and triggering a handover from VoLTE to VoWiFi by the UE.

Another embodiment provides a call service system including a network and user equipment (UE). New Radio (NR) connection is established between the network and the user equipment. The network is used to trigger a handover from NR to LTE. The user equipment in connection with the network is used to send first Measurement Report to the network when one of following conditions occurs: New Radio signal quality does not satisfy an NR signal threshold, Real-time Transport Protocol (RTP) measurement does not satisfy an RTP threshold, and the UE changes a calling preference to voice over Wi-Fi (VoWiFi). The user equipment is further used to trigger a handover from VoLTE to VoWiFi.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a scenario of wireless communication according to an embodiment of the present invention.

FIG. 2 is a flowchart illustrating a method for inter-RAT handover according to an embodiment of the present invention.

FIG. 3 is another illustration of the method for inter-RAT handover according to an embodiment of the present invention.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure. It should be understood that the disclosure is described primarily in the context of interworking between a 3GPP specified wireless network (e.g., 4G and 5G) and an IEEE 802.11 specified wireless network (e.g., Wi-Fi), but it can be implemented in other forms of cellular or non-cellular wireless networks as well.

In particular, the following technique, apparatus and system can be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, the implementation of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

As described by the 3GPP, different wireless communication systems standards and protocols can use various radio access networks (RANs) for communicating between a base station of the RAN (which may sometimes be referred to generally as a RAN node, a network node, or simply a node) and a wireless communication device known as user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

The RAN can include one or more access nodes, which may be referred to as base station, NodeB, evolved NodeB (eNB), next Generation NodeB (gNB), RAN nodes, controllers, transmission reception points (TRPs), and so forth, and can include ground stations (e.g., terrestrial access points) or satellite stations providing signal coverage within a geographic area (e.g., a cell). The RAN may include one or more RAN nodes for providing macrocells, picocells, femtocells, or other types of cells. A macrocell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having an association with the femtocell (e.g., UEs in a Closed Subscriber Group (CSG), UEs for users in the home, etc.).

A base station used by a RAN may correspond to that RAN. An example of an E-UTRAN base station is an Evolved Universal Terrestrial Radio Access Network (E-UTRAN) Node B (also referred to as evolved Node B, enhanced Node B, eNodeB, or eNB). Another example of an NG-RAN base station is a next generation Node B (also referred to as a gNodeB or gNB).

A RAN provides its communication services with external entities through its connection to a core network (CN). For example, E-UTRAN may utilize an Evolved Packet Core (EPC), while NG-RAN may utilize a 5G Core Network (5GC).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes referred to as LTE), and NG-RAN implements NR RAT (sometimes referred to as 5G RAT, 5G NR RAT, or NR). In certain deployments, the E-UTRAN may also implement NR RAT. In certain deployments, NG-RAN may also implement LTE RAT.

Inter-radio access technology (RAT) or I-RAT is a method of transferring a mobile device from one RAT to another. RAT is the underlying physical connection method for a radio communication network. Different RATs use different frequency bands, modulation schemes, and protocols. Inter-RAT handover is necessary when a mobile device moves out of the coverage area of one RAT and into the coverage area of another RAT. For example, a mobile device might be using 5G and then move into an area where only LTE is available. In this case, the device would need to handover to LTE in order to maintain its connection. I-RAT handover can be a complex process, as it involves coordinating the activities of the mobile device, the base stations of the two RATs, and the core network.

Depending on whether and how the core networks of the two networks are communicatively linked, a connected-mode inter-RAT handover procedure may or may not be supported by the system. In some cases, a system may support the connected-mode inter-RAT handover procedure in some geographic locations but not others. Where the system does not support the connected-mode inter-RAT handover procedure, user equipment (UE) may initiate an alternative inter-RAT mobility procedure that includes a release of radio connection, e.g., a radio connection release procedure according to a first RAT, followed by an initial attach or registration procedure according to a second RAT. By receiving, in advance, an indication of inter-RAT connected-mode mobility between the first RAT and the second RAT, the UE may determine which procedure is appropriate for transitioning from one RAT to another in a given location and thus avoid a trial-and-error approach, which may reduce latency.

The UE may receive the indication of inter-RAT upon performing an initial attach or registration procedure using a first RAT or upon performing a location update procedure in accordance with the first RAT. For example, the UE may receive the indication in conjunction with a random access process, such as an LTE Initial Attach or an NR Initial Registration, or in conjunction with a location update process, such as an LTE Tracking Area Update (TAU) procedure or an NR Normal (or Periodic) Registration procedure. In some such cases, the UE may receive the indication as part of an Attach Accept, a TAU Accept, or a Registration Accept message. The UE may receive the indication from a core network node corresponding to the first RAT, via, in some cases, a non-access stratum (NAS) protocol layer.

For terms and techniques not specifically described, reference may be made to wireless communication standard documents (e.g., 3GPP Specifications) issued before this specification.

Although not limited thereto, the various descriptions, functions, procedures, suggestions, methods, and/or operation flowcharts disclosed herein may be applied to various fields requiring wireless communication and/or connection (e.g., Wi-Fi, 5G) between devices.

In this specification, technical features that are individually described within one drawing may be implemented individually or simultaneously.

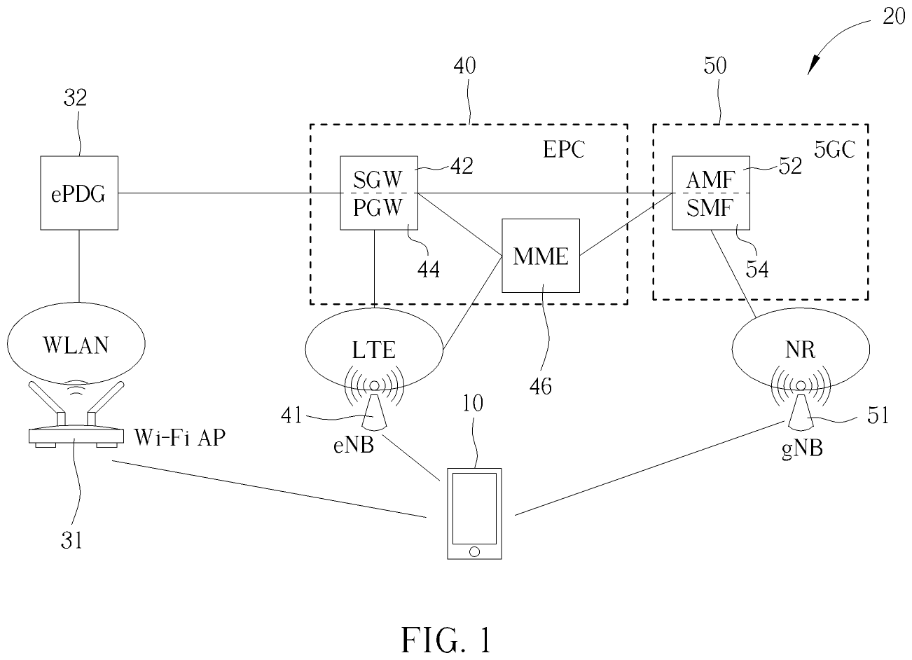

FIG. 1 illustrates a scenario of wireless communication according to an embodiment of the present invention. User equipment (UE) 10 is wirelessly connected with a network 20. The network 20 may include a 5G network (i.e., 5G core network (5GC) 50 and its associated components) and a 4G network (i.e., Evolved Packet Core (EPC) 40 and its associated components). It may also include a Wi-Fi network (i.e., Wi-Fi access point (AP) 31 and Evolved Packet Data Gateway (ePDG) 32) with its associated components. The UE 10 can be wirelessly connected with the 5G core network (5GC) 50 via a next Generation Node B (gNB) 51. (It should be noted that a Node B is a telecommunication node that facilitates wireless communication between UE and a network according to the 3GPP standard.) The UE 10 can also be wirelessly connected with the Evolved Packet Core (EPC) 40 via an evolved node B (eNB) 41. The UE 10 is also wirelessly connected with the Wi-Fi network via the Wi-Fi AP 31. The 5GC 50 includes several network components, such as an Access and Mobility Management Function (AMF) 52 and a Session Management Function (SMF) 54. The EPC 40 also includes several network components such as a Service Gateway (SGW) 42, the Public Data Network (PDN) gateway (PGW) 44 and a Mobility Management Entity (MME) 46. The Wi-Fi AP 31 may communicate with the EPC 40 via the ePDG 32.

It should be noted that the 5G network and the 4G network may be 3GPP access networks; the Wi-Fi network may be a trusted or untrusted non-3GPP access network.

The 5GC 50 is designed to handle the data and services of 5G communication. The 5GC 50 has several network functions (e.g., AMF 52 and SMF 54) that can be deployed as software components on cloud platforms. The AMF 52 is a component of the 5GC 50 responsible for managing the registration, authentication, reachability, mobility and session management of the user equipment 10. The AMF 52 may interact with other network functions such as the unified data management (UDM), the session management function (SMF) and the network slice selection function (NSSF) to provide seamless and secure connectivity to the UE 10 across different access networks and network slices. On the other hand, the SMF 54 is another component of the 5GC 50 responsible for establishing, modifying and releasing the sessions between the user equipment 10 and the data network. The SMF 54 also handles the allocation of IP addresses, the selection of gateways and the enforcement of quality of service (QoS) policies for each session.

The evolved packet core (EPC) 40 is the core network architecture of the 4G and 5G mobile networks. It provides the main functions of mobility management, session management, authentication, security, and interworking with other networks. The SGW 42 is a network component that acts as an interface between different service domains, such as cloud, edge, or enterprise. The SGW 42 may enable seamless communication and data exchange among various services, applications, and devices. The SGW 42 can also provide security, routing, load balancing, and other functions to optimize the performance and reliability of service delivery. The PGW 44 is a network component that communicates the UE 10 to a packet data network (PDN). It is responsible for IP address allocation, policy enforcement, charging, and routing of packets to and from the UE 10. The PGW 44 can support multiple PDNs for a single UE, such as Multimedia Messaging Service (MMS) and IP Multimedia Subsystem (IMS).

The Mobility Management Entity (MME) 46 is also a network component that handles the control plane functions of the EPC 40. It is responsible for managing the mobility and security of the user equipment (UE) 10 and communicating with other core network component such as the SGW 42 and the PGW 44. The MME 46 may also communicate with the 5G core network components such as the AMF 52 and the SMF 54. In addition, the MME 46 may be responsible for authentication and authorization of the UE 10, location management, session management, etc. In addition, the SGW 42 and PGW 44 may communicate with the AMF 52 and SMF 54 via 3GPP specified interfaces (e.g., interfaces N4 and N11).

The evolved Packet Data Gateway (ePDG) 32 is a network component that enables connectivity between LTE and Wi-Fi networks. It may act as an interface between the 3GPP core network and the untrusted non-3GPP access network, such as a public or private Wi-Fi AP. The ePDG 32 may support IPsec tunneling and encryption to provide secure data transmission and authentication for the users and may also support voice over Wi-Fi (VoWiFi) service, which allow users to make and receive calls over Wi-Fi networks. Therefore the ePDG 32 may be an interface to access network 20 through the untrusted non-3GPP access network, such as the Wi-Fi network associated with the Wi-Fi AP 31.

Currently, the network operator's core network (e.g., 5GC 50) does support direct handover between VoNR and VoWiFi. This means that the call may be dropped or interrupted when the poor NR signal quality occurs. This can cause user dissatisfaction and affect the quality of service. The following paragraphs describe a solution that can enable smooth and reliable inter-radio access technology (inter-RAT) handover between VoNR and VoWiFi in 5G networks.

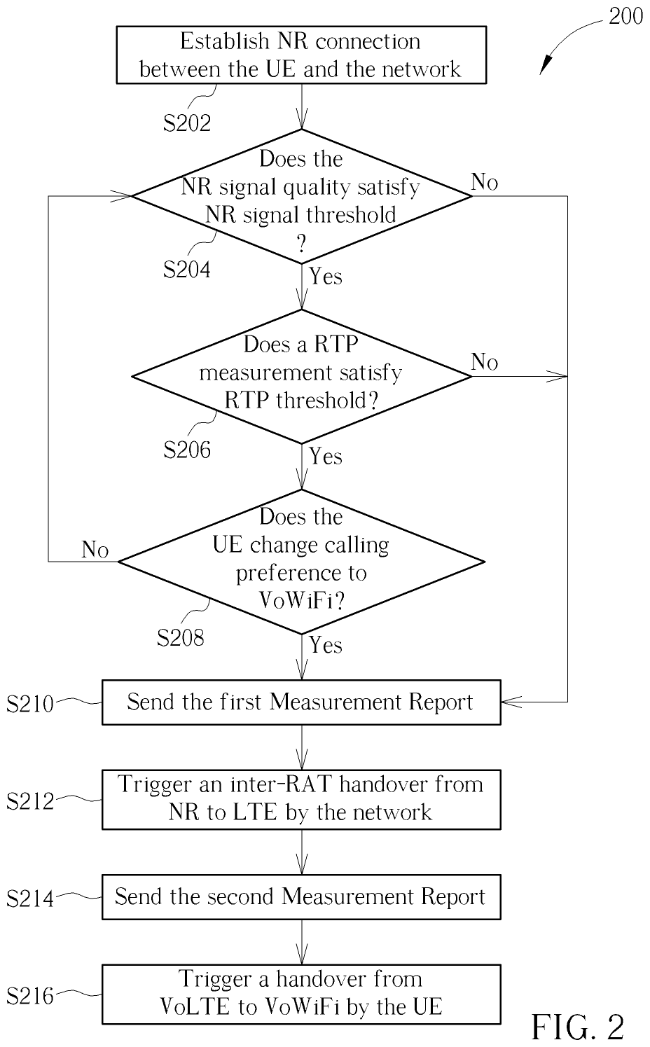

FIG. 2 is a flowchart illustrating a method 200 for inter-RAT handover according to an embodiment of the present invention. The method 200 can be implemented in the scenario described by FIG. 1. The method 200 includes the following steps:
S202: Establish NR connection between UE 10 and a network 20;
S204: Does the NR signal quality satisfy the NR signal threshold? If so, proceed to S206; if not, proceed to S210;
S206: Does the Real-time Transport Protocol (RTP) measurement satisfy the RTP threshold? If so, proceed to S208; if not, proceed to S210;
S208: Does the UE 10 change a calling preference to VoWiFi? If so, proceed to S210; if not, go back to S204;
S210: Send the first Measurement Report by the UE 10 to the network 20;
S212: Trigger an inter-RAT handover from NR to LTE by the network 20;
S214: Send the second Measurement Report by the UE 10 to the network 20; and
S216: Trigger a handover from VoLTE to VoWiFi by the UE 10.

After the handover from VoLTE to VoWiFi is triggered, the ePDG 32 may setup a handover of IMS PDN connection from LTE to Wi-Fi.

It should be noted that the NR signal quality and the LTE signal quality can be measured by Reference Symbol Received Power (RSRP) and/or Reference Signal Received Quality (RSRQ). For example, the NR signal quality may not satisfy the NR signal threshold when the RSRP is less than-120 dBm; the LTE signal quality may not satisfy the LTE signal threshold when the RSRP is less than-120 dBm. In another example, the RTP measurement may not satisfy the RTP threshold when an RTP loss rate is greater than 50 percent. The thresholds can be easily modified according to the actual implementation, and the disclosure is not limited herein.

It should also be noted that the first Measurement Report may be adjusted by the UE 10 to indicated poor NR signal quality and good LTE signal quality. For example, the first Measurement Report may indicate that the RSRP of the NR signal may be less than-120 dBm, and the RSRP of the LTE signal may be greater than-90 dBm. As a result, the network 20 may trigger the inter-RAT handover from NR to LTE.

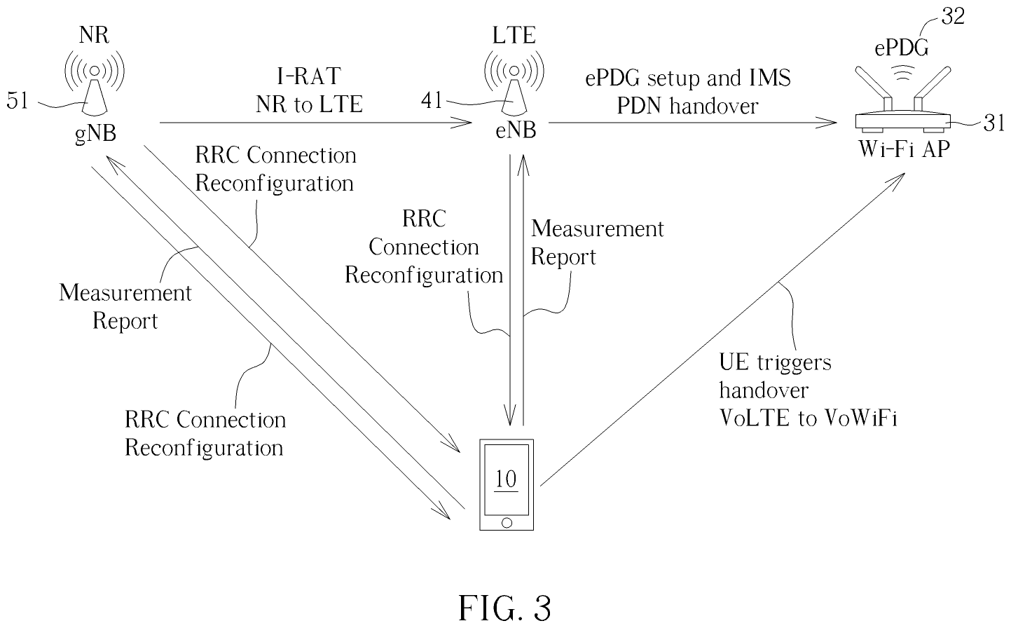

FIG. 3 is another illustration of the method for inter-RAT handover according to an embodiment of the present invention. Firstly, the gNB 51 may proceed with the RRC (Radio Resource Control) Connection Reconfiguration procedure to establish NR connection between the gNB 51 and the UE 10. When the connection is established, the UE 10 may send Measurement Report to the gNB 51 periodically. When one of the conditions in steps S204 to S208 occurs, the UE 10 may adjust the RSRP in the Measurement Report to indicate poor NR signal quality (e.g., NR RSRP<−120 dBm) and good LTE signal quality (e.g., LTE RSRP>−120 dBm). When the gNB 51 receives such Measurement Report, it may proceed with the Inter-RAT (I-RAT) procedure (as specified by 3GPP) to handover the wireless service from NR to LTE.

At this time, the eNB 41 may proceed with the RRC Connection Reconfiguration procedure to establish LTE connection between the eNB 41 and the UE 10. When the connection is established, the UE 10 may send Measurement Report to the eNB 41 periodically. In a scenario where the LTE signal is poor, the Measurement Report may indicate poor LTE signal quality (e.g., RSRP<−90 dBm or RSRQ<−18) to reflect the poor LTE signal quality. Then, the UE 10 may trigger a handover from VoLTE to VoWiFi, assuming the UE 10 is connected to the Wi-Fi AP 31 and has good signal quality (e.g., RSSI>−60 dBm). The ePDG 32 may proceed with a 3GPP specified procedure for a handover of IMS PDN connection from LTE to Wi-Fi. This would complete the process of call service handover from VoNR to VoWiFi.

It should be further noted that IMS PDN stands for IP Multimedia Subsystem Packet Data Network. It may be a standalone component that resides outside the LTE network and is connected to the PDN Gateway through the SGi interface. The IMS PDN is responsible for providing multimedia services such as voice, video, and messaging over an IP network. It is also used in 5G networks to provide multimedia services over an IP network. Thus, the handover of IMS PDN connection from LTE to Wi-Fi allows packet switching based voice call to be established between a non-3GPP network and a 3GPP network.

It should also be noted that RRC Connection Reconfiguration is a 3GPP specified procedure that allows a network to modify the radio configuration of UE. The network can change the radio bearers, the mobility parameters, the measurement configuration, and other aspects of the radio link. The RRC Connection Reconfiguration procedure is initiated by the network sending an RRC Connection Reconfiguration message to the UE, which contains the new configuration information. The UE applies the new configuration and sends an RRC Connection Reconfiguration Complete message to the network to confirm the successful completion of the procedure.

The UE as described in this disclosure may include a device with radio communication capabilities. For example, the UE may include a smartphone (e.g., handheld touchscreen mobile computing devices connectable to one or more cellular networks). The UE may also include any mobile or non-mobile computing device, such as Personal Data Assistants (PDAs), pagers, laptop computers, desktop computers, wireless handsets, or any computing device that has a wireless communications interface.

The UE may also be referred to as a client, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE may include IoT UE, which can include a network access layer designed for low-power IoT applications utilizing short-lived UE connections. IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UE, which may include uniquely identifiable embedded computing devices (within the Internet infrastructure). The IoT UE may execute background applications (e.g., keep-alive messages, status updates, etc.) to facilitate the connections of the IoT network.

Furthermore, the UE may be configured to connect or communicatively couple with the Radio Access Network (RAN) through a radio interface, which may be a physical communication interface or layer configured to operate with cellular communication protocols such as a GSM protocol, a CDMA network protocol, a Push-to-Talk (PTT) protocol, a PTT over Cellular (POC) protocol, a UMTS protocol, a 3GPP LTE protocol, a 5G protocol, a NR protocol, and the like. For example, the UE and the RAN may use a Uu interface (e.g., an LTE-Uu interface) to exchange control plane data via a protocol stack comprising a PHY layer, an MAC layer, an RLC layer, a PDCP layer, and an RRC layer. A DL transmission may be from the RAN to the UE and a UL transmission may be from the UE to the RAN. The UE may further use a sidelink to communicate directly with another UE (not shown) for D2D, P2P, and/or ProSe communication. For example, a ProSe interface may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

Several aspects of a telecommunications system has been presented with reference to 5G (NR) and 4G (LTE) systems. As those skilled in the art will readily appreciate, various aspects described throughout this disclosure may be extended to other telecommunication systems, network architectures and communication standards. By way of example, various aspects may be extended to other telecommunications systems such as High Speed Downlink Packet Access (HSDPA), High Speed Uplink Packet Access (HSUPA), High Speed Packet Access Plus (HSPA+) and TD-CDMA. Various aspects may also be extended to systems employing, Global System for Mobile Communications (GSM), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wire or wireless means) information signals (whether containing voice information or non-voice data/control information) to/from the second entity regardless of the type (analog or digital) of those signals. It is further noted that various figures (including component diagrams) shown and discussed herein are for illustrative purpose only, and are not drawn to scale.

The various illustrative logical blocks, modules, functions, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In some embodiments, the computing instructions may be carried out by an operating system, for example, Microsoft Windows™, Apple Mac OS/X or iOS operating systems, some variety of the Linux operating system, Google Android™ operating system, or the like.

In some embodiments, the computers may be on a distributed computing network, such as one having any number of clients and/or servers. Each client may run software for implementing client-side portions of the embodiments. In addition, any number of servers may be provided for handling requests received from one or more clients. Clients and servers may communicate with one another via one or more electronic networks, which may be in various embodiments such as the Internet, a wide area network, a mobile telephone network, a wireless network (e.g., Wi-Fi, 5G, and so forth), or a local area network. Networks may be implemented using any known network protocols.

Reference has been made in detail to implementations, examples of which are illustrated in the accompanying drawings. In the detailed description above, numerous specific details have been set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for inter-radio access technology (inter-RAT) handover, comprising:
establishing New Radio (NR) connection between user equipment (UE) and a network;
sending first Measurement Report by the UE to the network when one of following conditions occurs:
New Radio (NR) signal quality does not satisfy an NR signal threshold;
Real-time Transport Protocol (RTP) measurement does not satisfy an RTP threshold; and
the UE changes a calling preference to voice over Wi-Fi (VoWiFi);
triggering a handover from NR to LTE (Long Term Evolution) the network; and
triggering a handover from voice over LTE (VoLTE) to VoWiFi by the UE.

2. The method of claim 1, wherein the first Measurement Report indicates the New Radio (NR) signal quality does not satisfy the NR signal threshold.

3. The method of claim 1, wherein the NR signal quality is measured by Reference Symbol Received Power (RSRP) and/or Reference Signal Received Quality (RSRQ).

4. The method of claim 1, wherein the NR signal quality does not satisfy the NR signal threshold when Reference Symbol Received Power (RSRP) of the NR signal is less than-120 dBm.

5. The method of claim 1 further comprising sending second Measurement Report by the UE.

6. The method of claim 5, wherein the second measurement report indicates the NR signal quality does not satisfy the NR signal threshold, and LTE signal quality does not satisfy a LTE signal threshold.

7. The method of claim 6, wherein the NR signal quality and the LTE signal quality are measured by Reference Symbol Received Power (RSRP) and/or Reference Signal Received Quality (RSRQ).

8. The method of claim 6, wherein the NR signal quality does not satisfy the NR signal threshold when Reference Symbol Received Power (RSRP) of the NR signal is less than-120 dBm, and LTE signal quality does not satisfy the LTE signal threshold when RSRP of the LTE signal is less than-120 dBm.

9. The method of claim 1, wherein the RTP measurement does not satisfy the RTP threshold when a RTP loss rate is greater than 50 percent.

10. The method of claim 1 further comprising setting up an Evolved Packet Data Gateway (ePDG) for a handover of an Internet Protocol (IP) Multimedia Subsystem (IMS) public data network (PDN) from LTE to Wi-Fi.

11. A call service system comprising:
a network configured to trigger a handover from New Radio (NR) to LTE (Long Term Evolution); and
user equipment (UE) in connection with the network, configured to:
send first Measurement Report to the network when one of following conditions occurs:
New Radio (NR) signal quality does not satisfy an NR signal threshold;
Real-time Transport Protocol (RTP) measurement does not satisfy an RTP threshold; and
the UE changes a calling preference to voice over Wi-Fi (VoWiFi); and
trigger a handover from VoLTE to VoWiFi;
wherein NR connection is established between the network and the UE.

12. The call service system of claim 11, wherein the first Measurement Report indicates the New Radio (NR) signal quality does not satisfy the NR signal threshold.

13. The call service system of claim 11, wherein the NR signal quality is measured by Reference Symbol Received Power (RSRP) and/or Reference Signal Received Quality (RSRQ).

14. The call service system of claim 11, wherein the NR signal quality does not satisfy the NR signal threshold when Reference Symbol Received Power (RSRP) of the NR signal is less than-120 dBm.

15. The call service system of claim 11, wherein the UE is further configured to send second Measurement Report.

16. The call service system of claim 15, wherein the second measurement report indicates the NR signal quality does not satisfy the NR signal threshold, and LTE signal quality does not satisfy an LTE signal threshold.

17. The call service system of claim 16, wherein the NR signal quality and the LTE signal quality are measured by Reference Symbol Received Power (RSRP) and/or Reference Signal Received Quality (RSRQ).

18. The call service system of claim 16, wherein the NR signal quality does not satisfy the NR signal threshold when Reference Symbol Received Power (RSRP) of the NR signal is less than-120 dBm, and LTE signal quality does not satisfy the LTE signal threshold when RSRP of the LTE signal is less than-120 dBm.

19. The call service system of claim 11, wherein the RTP measurement does not satisfy the RTP threshold when a RTP loss rate is greater than 50 percent.

20. The call service system of claim 11 wherein the network comprises an Evolved Packet Data Gateway (ePDG) configured for a handover of Internet Protocol (IP) Multimedia Subsystem (IMS) public data network (PDN) from LTE to Wi-Fi.
